(19) United States
(12) Patent Application Publication
(10) Pub. No.: US 2015/0014109 A1
(43) Pub. Date: Jan. 15, 2015

(54) Luggage Case with Double Lock

(71) Applicant: Wei-Hung LAI, Taichung City (TW)

(72) Inventor: Wei-Hung LAI, Taichung City (TW)

(21) Appl. No.: 13/937,215

(22) Filed: Jul. 9, 2013

(51) Int. Cl. A45C 13/10; E05B 65/52; A45C 5/03

(52) U.S. Cl. CPC A45C 13/103; A45C 5/03; E05B 65/52
USPC 190/111

(57) ABSTRACT

A luggage case with double lock is provided with a case body, a first cover, a second cover, and a lock device fixed on the first cover. The locking device is provided with a base, a first locking member, a second locking member, a first press button, a second press button, a locking unit, and a lock device. The base is disposed on a lateral outer surface of the first cover and includes an inner and outer locking slots for holding two pull tabs of two zippers of the luggage case in such a manner that the first and second locking member each have a pin inserted in the holes of the two pull tabs, so that the two zippers of the luggage are locked synchronously to prevent unauthorized opening of the luggage case and stealing of goods contained therein.

### BACKGROUND OF THE INVENTION

1. Field of the Invention

The present invention relates to a luggage case, and more particularly to a luggage case with double lock.

2. Description of the Prior Art

Luggage cases are mostly provided with locks in order to prevent someone opening the case and stealing the goods contained in the case.

FIG. 1 is a side view of a conventional luggage case with locking function, wherein the luggage case comprises a case body 11, a first cover 13 which is pivoted to the case body 11 to define a first chamber 12 with respect to the case body 11, a second cover 15 which is pivoted to the first cover 13 to define a second chamber 14 with respect to the first cover 13, a first zipper 16 disposed between the case body 11 and the first cover 13, a second zipper 17 disposed between the first cover 13 and the second cover 15, and a lock 18 fixed to the lateral side of the case body 11. The lock 18 serves to lock the first zipper 16 so as to prevent unauthorized opening of the case body 11 and the first cover 13 and stealing of goods contained therein.

The problem is that the lock 18 is located at the lateral side of the case body 11 to lock the first zipper 16, only the first chamber 12 can be protected from stealing, however, the second zipper 17 cannot be locked by the lock 18, therefore, the second chamber 14 is not lockable.

The present invention has arisen to mitigate and/or obviate the afore-described disadvantages.

### SUMMARY OF THE INVENTION

The primary objective of the present invention is to provide a luggage case with double lock, wherein two zippers of the luggage case can be locked simultaneously by changing the structural design of the lock device and placing the lock device at the specific positions on the luggage case, so as to prevent unauthorized opening of the luggage case and stealing of goods contained therein.

To achieve the above objective, a luggage case with double lock in accordance with the present invention comprises a case body, a first cover which is pivotally connected to and cooperates with the case body to define a first chamber, a second cover which is pivotally connected to and cooperates with the first cover to define a second chamber, a first row of inner teeth disposed on the case body, a second row of inner teeth disposed at one side of the first cover and located opposite the first row of inner teeth, two first sliders movably disposed between the first and second rows of inner teeth to bring together or separate the first and second rows of inner teeth, two first pull tabs which are disposed on the two first sliders and each have a first hole, a first row of outer teeth disposed at another side of the first cover, a second row of outer teeth disposed on the second cover and located opposite the first row of outer teeth, two second sliders movably disposed between the first and second rows of outer teeth to bring together or separate the first and second rows of outer teeth, two second pull tabs which are disposed on the two second sliders and each have a second hole, and a lock device fixed at the first cover and comprises:

a base fixed at a lateral outer surface of the first cover and including an inner edge located adjacent to the second row of inner teeth, an outer edge opposite the inner edge and located closer to the first row of outer teeth than the inner edge, two inner locking slots which extend from the inner edge toward the outer edge and are provided for holding the first holes, and two outer locking slots which extend from the outer edge toward the inner edge and are provided for holding the second holes;

a first locking member disposed in the base and including two first pins which are capable of being pushed out of the inner locking slots synchronously, and under normal conditions, the first pins are located in the inner locking slots and capable of inserting in the first holes;

a second locking member disposed in the base and including two second pins which are capable of being pushed out of the outer locking slots synchronously, and under normal conditions, the second pins are located in the outer locking slots and capable of inserting in the second holes ;

a first press button capable of returning to its original position after release and disposed in the base to effect synchronous disengagement of the two first pins of the first locking member from the inner locking slots;

a second press button capable of returning to its original position after release and disposed in the base to effect synchronous disengagement of the two second pins of the second locking member from the outer locking slots; and

a locking unit disposed in the base to control movement of the first and second locking members.

Preferably, the base further includes a first stop portion, a second stop portion, a holding portion located between the first and second stop portions for holding the locking unit, two third stop portions arranged around the periphery of the holding portion, two fourth stop portions for stopping the two first pins of the first locking member, and two fifth stop portions for stopping the two second pins of the second locking member; the first locking member further comprises a first rod and a first abutting portion opposite the first rod, between the two first pins and the two fourth stop portions are disposed two first springs, the second locking member further comprises a second rod and a second abutting portion opposite the second rod, between the two second pins and the two fifth stop portions are disposed another two springs, the first press button includes a first inserting groove for insertion of the first rod, and a first hook capable of abutting against or moving away from the first stop portion, the second press button includes a second inserting groove for insertion of the second rod and a second hook capable of abutting against or moving away from the second stop portion, the locking unit is a lock which is provided with two protrusions capable of abutting against or moving away from the third stop portions, when abutting against the third stop portions, the protrusions are staggered with respect to the first abutting portions of the first locking member and the second abutting portions of the second locking member, and when moving away from the third stop portions, the protrusions are simultaneously abutted against the first locking member and the second abutting portions of the second locking member.

Preferably, the locking unit further comprises a code lock capable of stopping and allowing the first and second locking members to move.

Preferably, the locking unit is a code lock.

### BRIEF DESCRIPTION OF THE DRAWINGS

FIG. 1 is a side view of a conventional luggage case with locking function;

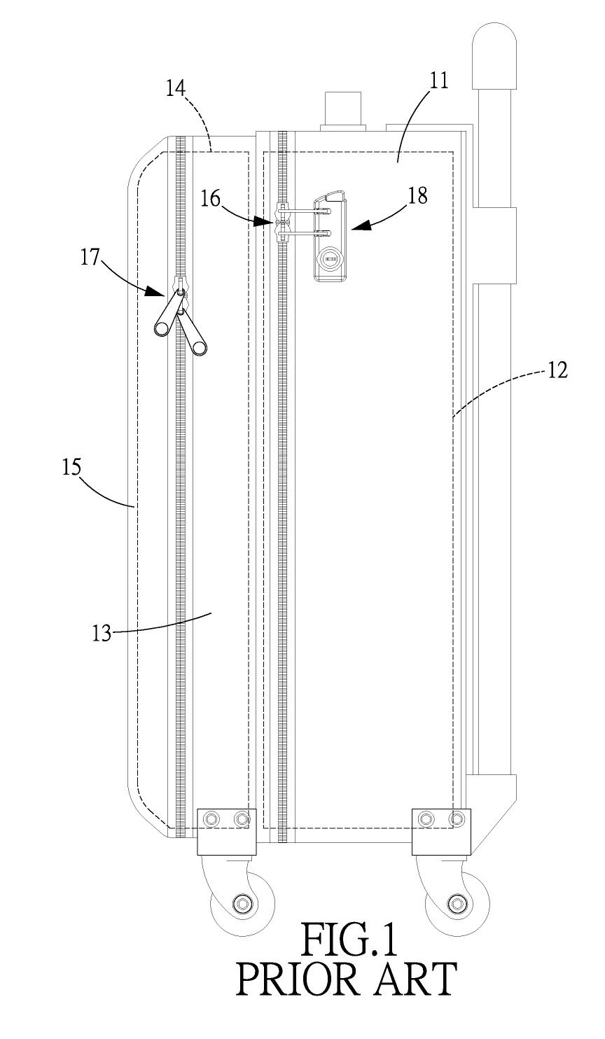

FIG. 2 is a side view showing that a luggage case with double lock in accordance with a first embodiment of the present invention is fixed on a luggage case;

FIG. 3 is an enlarged view of a part of FIG. 2;

FIG. 4 is a perspective view of the luggage case with double lock in accordance with the first embodiment of the present invention;

FIG. 5 is a front view of the luggage case with double lock in accordance with the first embodiment of the present invention;

FIG. 6 is an enlarged view of a luggage case with double lock in accordance with a second embodiment of the present invention;

FIG. 7 is an enlarged view of a luggage case with double lock in accordance with a third embodiment of the present invention;

FIG. 8 is a cross sectional view showing the interior structure of the locking device in accordance with the present invention;

FIG. 9 is a cross sectional view showing that the first and second press buttons of the lock device in accordance with the present invention are being pressed down; and

FIG. 10 is a cross sectional view showing that the luggage case with double lock in accordance with the present invention is a locked position.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

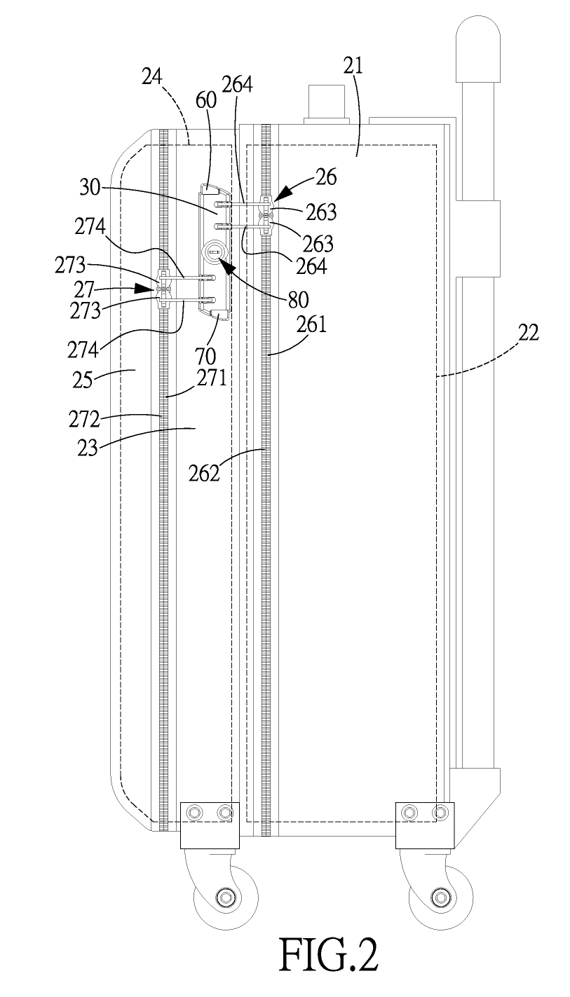

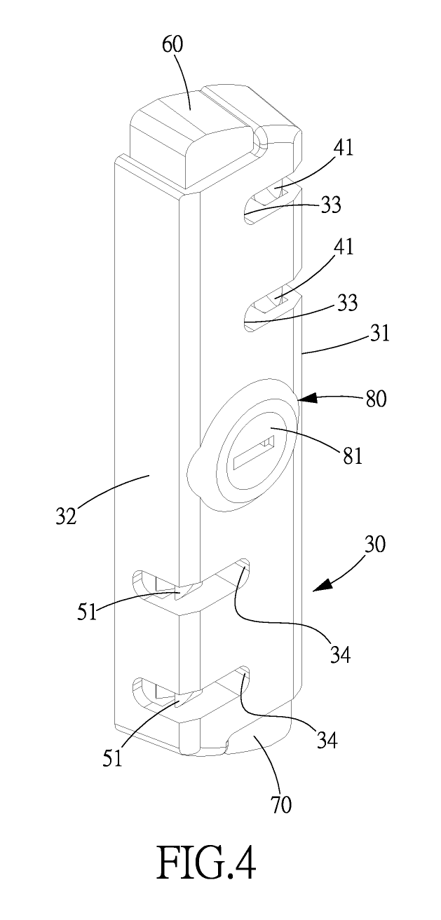

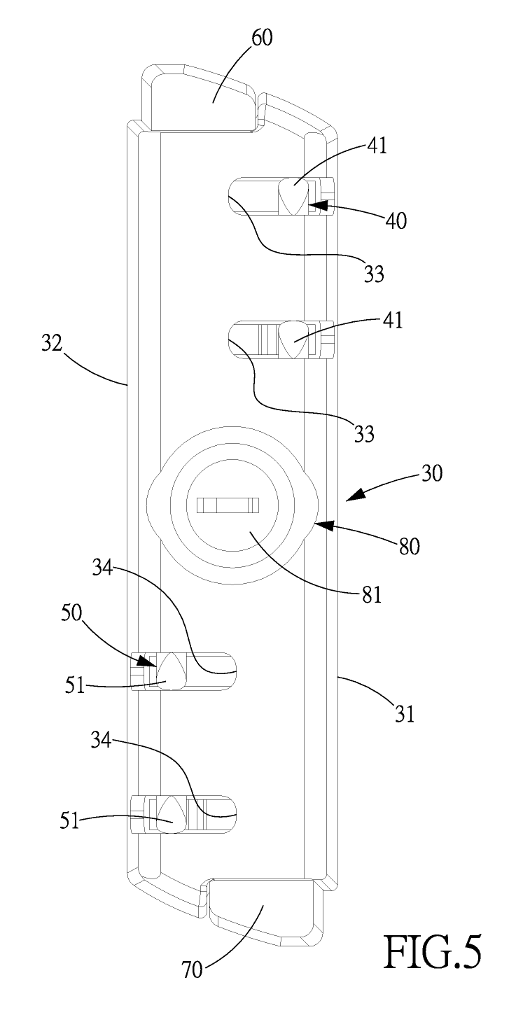

Referring to FIGS. 2-5, a luggage case with double lock in accordance with the present invention is shown and comprises the following components;

a case body 21;

a first cover 23 which is pivotally connected to and cooperates with the case body 21 to define a first chamber 22;

a second cover 25 which is pivotally connected to and cooperates with the first cover 23 to define a second chamber 24;

a first row of inner teeth 261 disposed on the case body 21;

a second row of inner teeth 262 disposed at one side of the first cover and located opposite the first row of inner teeth 261;

two first sliders 263 movably disposed between the first and second rows of inner teeth 261, 262 to bring together or separate the first and second rows of inner teeth 261, 262;

two first pull tabs 264 which are disposed on the two first sliders 263 and each have a first hole 2641;

a first row of outer teeth 271 disposed at another side of the first cover 23;

a second row of outer teeth 272 disposed on the second cover 25 and located opposite the first row of outer teeth 271;

two second sliders 273 movably disposed between the first and second rows of outer teeth 271, 272 to bring together or separate the first and second rows of outer teeth 271, 272;

two second pull tabs 274 which are disposed on the two second sliders 273 and each have a second hole 2741; and

a lock device which is fixed on the first cover 23 and comprises a base 30, a first locking member 40, a second locking member 50, a first press button 60, a second press button 70 and a locking unit 80.

The first and second rows of inner teeth 261, 262, the two first sliders 263, and the two first pull tabs 264 constitute a first zipper 26. The first and second rows of outer teeth 271, 272, the two second sliders 273, and the two second pull tabs 274 constitute a second zipper 27.

The base 30 is fixed at a lateral outer surface of the first cover 23 and includes an inner edge 31 located adjacent to the second row of inner teeth 262, an outer edge 32 opposite the inner edge 31 and located closer to the first row of outer teeth 271 than the inner edge 31, two inner locking slots 33 which extend from the inner edge 31 toward the outer edge 32 and are provided for holding the first holes 2641, and two outer locking slots 34 which extend from the outer edge 32 toward the inner edge 31 and are provided for holding the second holes 2741.

The first locking member 40 is disposed in the base 30 and includes two first pins 41 which are capable of disengaging from the inner locking slots 33 synchronously when being pushed, and under normal conditions, the first pins 41 are located in the inner locking slots 33 and capable of inserting in the first holes 2641.

The second locking member 50 is disposed in the base 30 and includes two second pins 51 which are capable of disengaging from the outer locking slots 34 synchronously when being pushed, and under normal conditions, the second pins 51 are located in the outer locking slots 34 and capable of inserting in the second holes 2741.

The first press button 60 is capable of returning to its original position after release and disposed in the base 30 to effect synchronous disengagement of the two first pins 41 of the first locking member 40 from the inner locking slots 33.

The second press button 70 is capable of returning to its original position after release and disposed in the base 30 to effect synchronous disengagement of the two second pins 51 of the second locking member 50 from the outer locking slots 34.

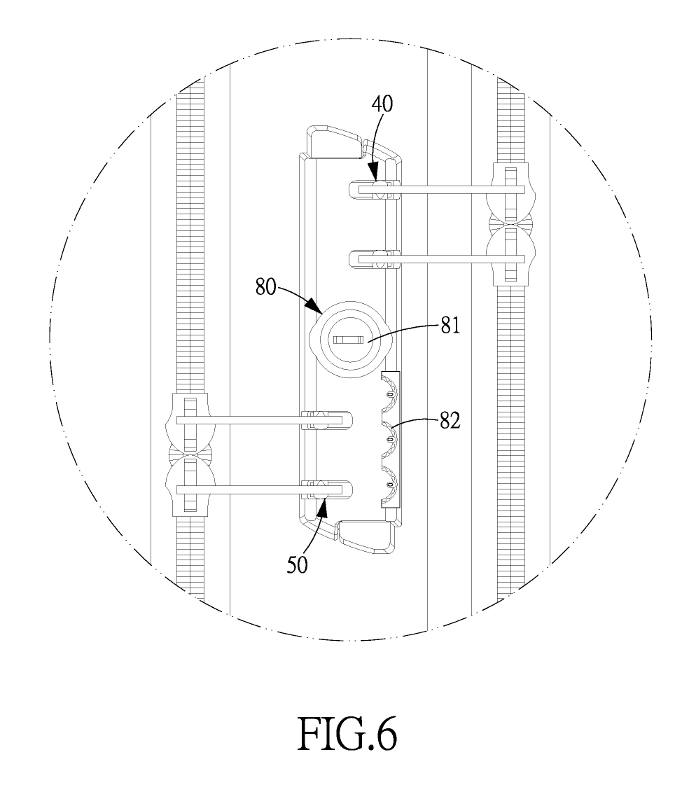

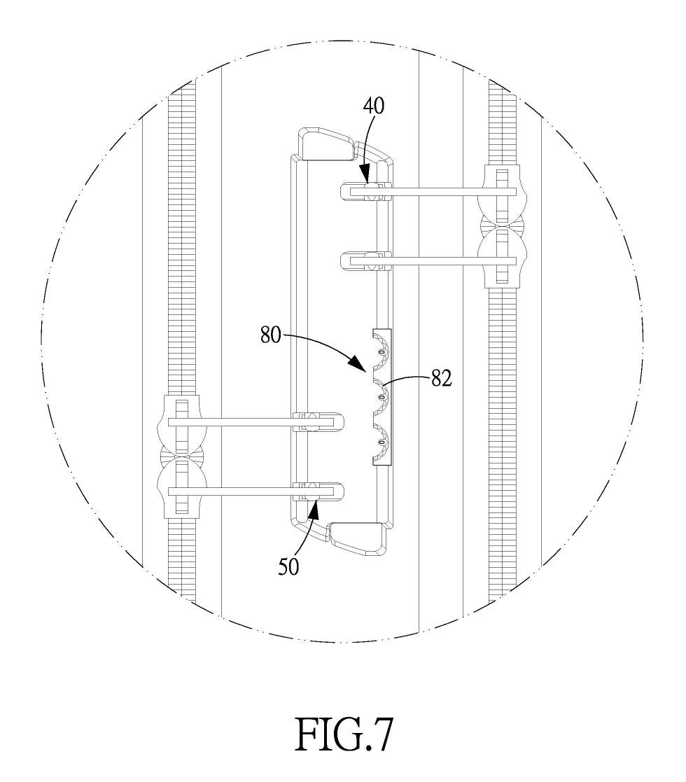

The locking unit 80 is disposed in the base 30 to control the movement of the first and second locking members 40, 50. In this embodiment, the locking unit 80 is an ordinary lock 81, or as shown in FIG. 6, it can also include an ordinary lock 81 and a code lock 82 which respectively are capable of stopping and allowing the first and second locking members 40, 50 to move. Or, as shown in FIG. 7, the locking unit 80 can just be a code lock. Since the way that the locking unit 80 controls the movement of the first and second locking members 40, 50 is the same as the conventional art and is not the key feature of the present invention, further details on this matter would seem unnecessary.

Since the base 30 of the lock device is disposed at the lateral outer surface of the first cover 23 located between the case body 21 and he second cover 25 and includes the inner locking slots 33 for accommodation of the first holes 2641 of the two first pull tabs 264, and the outer locking slots 34 for accommodation of the second holes 2741 of the two second pull tabs 274, the two first pull tabs 264 can be inserted in the inner locking slots 33 in such a manner that the first holes 2641 are located in the inner locking slots 33, and then the first pins 41 of the first locking member 40 are inserted in the first holes 2641, so as to lock the first pull tabs 264. Similarly, the two second pull tabs 274 can also be inserted in the outer locking slots 34 in such a manner that the second holes 2741 are located in the outer locking slots 34, and then the second pins 51 of the second locking member 50 are inserted in the second holes 2741 to lock the two second pull tabs 274.

The present invention is capable of simultaneously locking two zippers of a luggage case by changing the structural design of the lock device and placing the lock device at the specific positions on the luggage case, so as to prevent unauthorized opening of the luggage case and stealing of goods contained therein.

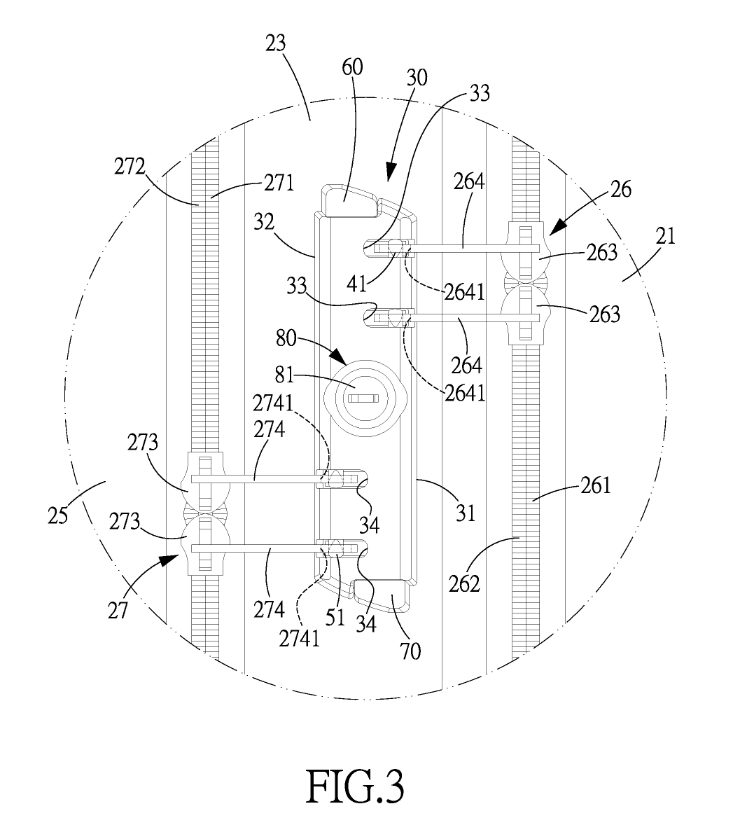

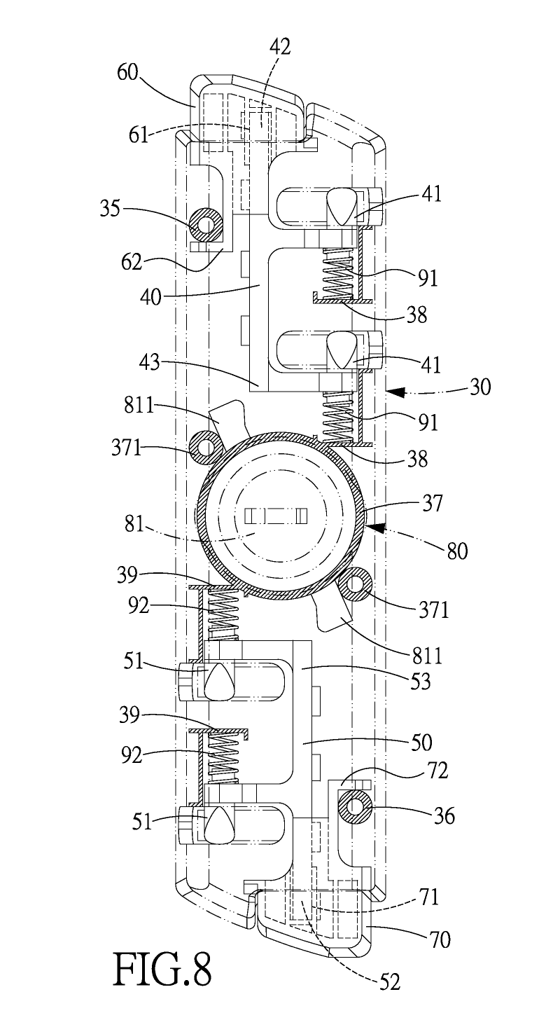

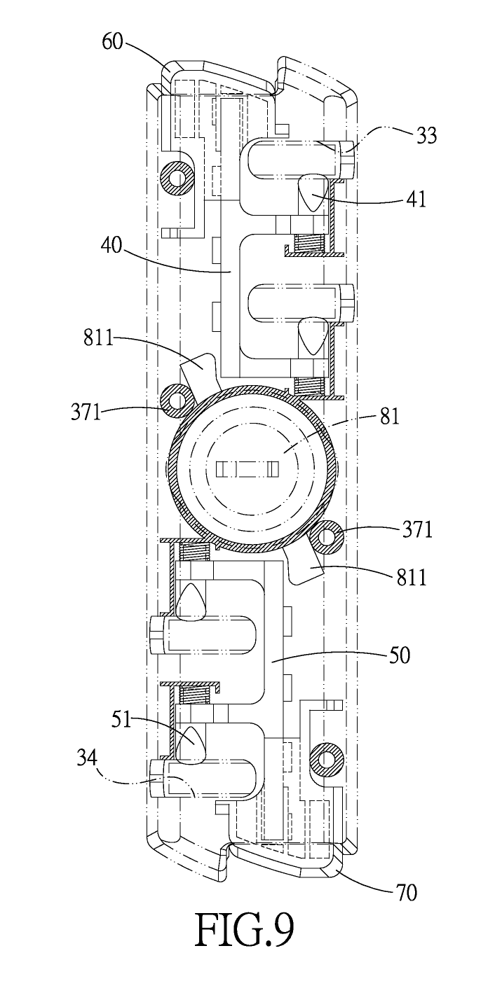

It is to be noted that, as shown in FIGS. 3, 5 and 8-10, the structures and operations of the first locking member 40 for locking the first pull tabs 264, the first press button 60 for controlling the first locking member 40, the second locking member 50 for locking the second pull tabs 274, the second press button 70 for controlling the second locking member 50, and the locking unit 80 for controlling the motion of the first and second locking members 40, 50, are explained as follows.

The base 30 further includes a first stop portion 35, a second stop portion 36, a holding portion 37 located between the first and second stop portions 35, 36 for holding the locking unit 80, two third stop portions 371 arranged around the periphery of the holding portion 37, two fourth stop portions 38 for stopping the two first pins 41 of the first locking member 40, and two fifth stop portions 39 for stopping the two second pins 51 of the second locking member 50.

The first locking member 40 further comprises a first rod 42 and a first abutting portion 43 opposite the first rod 42. Between the two first pins 41 and the two fourth stop portions 38 are two first springs 91 which are capable of pushing the first locking member 40 back to its original position.

The second locking member 50 further comprises a second rod 52 and a second abutting portion 53 opposite the second rod 52. Between the two second pins 51 and the two fifth stop portions 39 are two springs 92 which are capable of pushing the second locking member 50 back to its original position.

The first press button 60 includes a first inserting groove 61 for insertion of the first rod 42, and a first hook 62 capable of abutting against or moving away from the first stop portion 35. The first rod 42 is inserted in the first inserting groove 61 in such a manner that the first press button 60 moves synchronously and interactively with the first locking member 40, and the first hook 62 is abutted against the first stop portion 35 to prevent disengagement of the first press button 60 from the base 30.

The second press button 70 includes a second inserting groove 71 for insertion of the second rod 52 and a second hook 72 capable of abutting against or moving away from the second stop portion 36. The second rod 52 is inserted in the second inserting groove 71 in such a manner that the second press button 70 moves synchronously and interactively with the second locking member 50, and the second hook 72 is abutted against the second stop portion 36 to prevent the disengagement of the second press button 70 from the base 30.

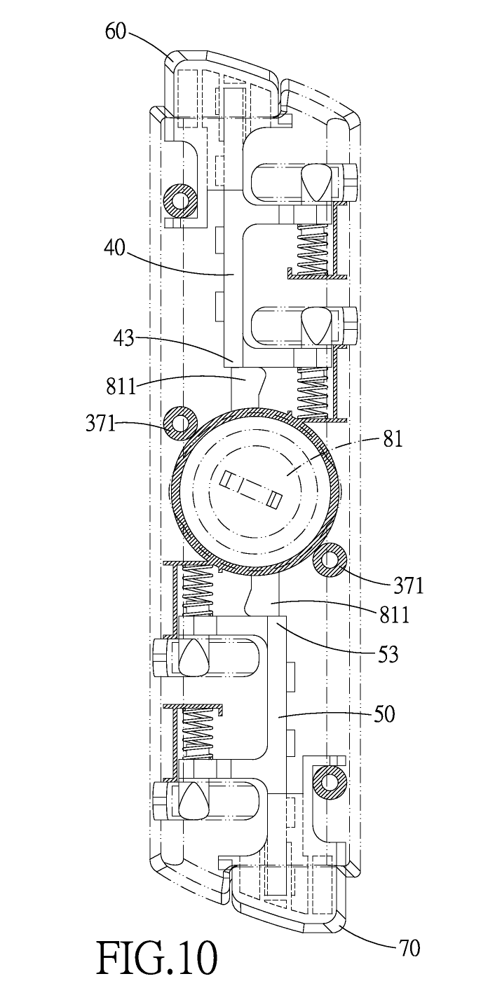

The locking unit 80 is a lock 81 which is provided with two protrusions 811 capable of abutting against or moving away from the third stop portions 371. When abutting against the third stop portions 371, the two protrusions 811 will be staggered with respect to the first abutting portions 43 of the first locking member 40 and the second abutting portions 53 of the second locking member 50, so that the first and second press buttons 60, 70 can be pressed to effect the movement of the first and second locking members 40, 50. When moving away from the third stop portions 371, the two protrusions 811 will simultaneously be abutted against the first locking member 40 and the second abutting portions 53 of the second locking member 50, so that the first and second press buttons 60, 70 cannot be pressed down to effect the movement of the first and second locking members 40, 50, putting the first and second locking members 40, 50 in a locked position, as shown in FIG. 10.

While we have shown and described various embodiments in accordance with the present invention, it is clear to those skilled in the art that further embodiments may be made without departing from the scope of the present invention.

What is claimed is:

1. A luggage case with double lock, comprising:
a case body;
a first cover which is pivotally connected to and cooperates with the case body to define a first chamber;
a second cover which is pivotally connected to and cooperates with the first cover to define a second chamber;
a first row of inner teeth disposed on the case body;
a second row of inner teeth disposed at one side of the first cover and located opposite the first row of inner teeth;
two first sliders movably disposed between the first and second rows of inner teeth to bring together or separate the first and second rows of inner teeth;
two first pull tabs which are disposed on the two first sliders and each have a first hole;
a first row of outer teeth disposed at another side of the first cover;
a second row of outer teeth disposed on the second cover and located opposite the first row of outer teeth;
two second sliders movably disposed between the first and second rows of outer teeth to bring together or separate the first and second rows of outer teeth;
two second pull tabs which are disposed on the two second sliders and each have a second hole; and
a lock device which is fixed on the first cover and comprises:
a base fixed at a lateral outer surface of the first cover and including an inner edge located adjacent to the second row of inner teeth, an outer edge opposite the inner edge and located closer to the first row of outer teeth than the inner edge, two inner locking slots which extend from the inner edge toward the outer edge and are provided for holding the first holes, and two outer locking slots which extend from the outer edge toward the inner edge and are provided for holding the second holes;
a first locking member disposed in the base and including two first pins which are capable of being pushed out of the inner locking slots synchronously, and under normal conditions, the first pins are located in the inner locking slots and capable of inserting in the first holes;
a second locking member disposed in the base and including two second pins which are capable of being pushed out of the outer locking slots synchronously, and under normal conditions, the second pins are located in the outer locking slots and capable of inserting in the second holes;
a first press button capable of returning to its original position after release and disposed in the base to effect synchronous disengagement of the two first pins of the first locking member from the inner locking slots;
a second press button capable of returning to its original position after release and disposed in the base to effect synchronous disengagement of the two second pins of the second locking member from the outer locking slots; and
a locking unit disposed in the base to control movement of the first and second locking members.

2. The luggage case as with double lock as claimed in claim 1, wherein the base further includes a first stop portion, a second stop portion, a holding portion located between the first and second stop portions for holding the locking unit, two third stop portions arranged around the periphery of the holding portion, two fourth stop portions for stopping the two first pins of the first locking member, and two fifth stop portions for stopping the two second pins of the second locking member; the first locking member further comprises a first rod and a first abutting portion opposite the first rod, between the two first pins and the two fourth stop portions are disposed two first springs, the second locking member further comprises a second rod and a second abutting portion opposite the second rod, between the two second pins and the two fifth stop portions are disposed another two springs, the first press button includes a first inserting groove for insertion of the first rod, and a first hook capable of abutting against or moving away from the first stop portion, the second press button includes a second inserting groove for insertion of the second rod and a second hook capable of abutting against or moving away from the second stop portion, the locking unit is a lock which is provided with two protrusions capable of abutting against or moving away from the third stop portions, when abutting against the third stop portions, the protrusions are staggered with respect to the first abutting portions of the first locking member and the second abutting portions of the second locking member, and when moving away from the third stop portions, the protrusions are simultaneously abutted against the first locking member and the second abutting portions of the second locking member.

3. The luggage case as with double lock as claimed in claim 2, wherein the locking unit further comprises a code lock capable of stopping and allowing the first and second locking members to move.

4. The luggage case as with double lock as claimed in claim 1, wherein the locking unit is a code lock.
